(19) United States
(12) Patent Application Publication
(10) Pub. No.: US 2019/0186425 A1
(43) Pub. Date: Jun. 20, 2019

(54) Canister

(71) Applicant: AISAN KOGYO KABUSHIKI KAISHA, Obu-shi (JP)

(72) Inventors: Taisuke KAGAU, Kariya-shi (JP); Makoto IIMI, Toyoake-shi (JP); Hiroshi SAKAGUCHI, Anjo-shi (JP)

(73) Assignee: AISAN KOGYO KABUSHIKI KAISHA, Obu-shi (JP)

(21) Appl. No.: 16/220,071

(22) Filed: Dec. 14, 2018

(30) Foreign Application Priority Data
Dec. 14, 2017 (JP) 2017-239340

(51) Int. Cl. F02M 25/08; B01D 53/02

(52) U.S. Cl. CPC F02M 25/0854; B01D 2253/102; B01D 53/02

(57) ABSTRACT

A canister includes a case having a fluid channel formed therein. In addition, the canister includes an adsorption chamber disposed in the fluid channel and containing an adsorbent. Further, the canister includes a filter disposed within the adsorption chamber and extending across an end portion of the adsorption chamber. The case may include a filter supporting portion facing the outer peripheral edge of the filter. The filter supporting portion may include fused portions to which the peripheral edge of the filter may be fusion-bonded and may also include non-fused portions to which the peripheral edge of the filter may not be fusion-bonded. The fused portions and the non-fused portions both may be disposed in an alternating manner in a lengthwise direction of the filter supporting portion about the filter supporting portion.

### CROSS-REFERENCE TO RELATED APPLICATION

This application claims benefit of Japanese Patent Application Serial No. 2017-239340 filed on Dec. 14, 2017, and entitled “Canister,” which is hereby incorporated by reference in its entirety for all purposes.

### STATEMENT REGARDING FEDERALLY SPONSORED RESEARCH OR DEVELOPMENT

Not applicable.

### BACKGROUND

This disclosure relates generally to canisters that adsorb and desorb fuel vapors generated in fuel systems of engines installed in a vehicle or the like.

U.S. Pat. No. 8,177,894 (B2), which is also published as Japanese Laid-Open Patent Publication No. 2010-007573, discloses a canister. This canister includes a case having a fluid channel formed therein, adsorption chambers containing adsorbent disposed in the fluid channel, and filters disposed within corresponding adsorption chambers to extend across an end portions of the corresponding adsorption chambers in a direction orthogonal to a flow direction of the fluid. The peripheral edge of each filter is fusion-bonded to the corresponding filter supporting portion about the entire filter supporting portion.

According to the above-described publication, “a ring weld projection” used to fuse the filter to the filter supporting portion of the case is required to be disposed about the entire filter supporting portion. This makes the structure (i.e., the configuration) of the case complex. Additionally, by virtue of the long fusion length, the associated fusion costs increase. It is notable that the fusion cost also includes expenses required for the amount of fusion energy, consumables, equipment, tools, and the like.

### SUMMARY

In one embodiment described herein, a canister includes a case having a fluid channel formed therein. In addition, the canister includes an adsorption chamber disposed in the fluid channel and containing an adsorbent. Further, a filter is disposed within the adsorption chamber and extending across an end portion of the adsorption chamber in a direction orthogonal to a flow direction of a fluid. The case also includes a filter supporting portion facing the outer peripheral edge of the filter. The filter supporting portion includes a plurality of fused portions to which the peripheral edge of the filter are fusion-bonded and a plurality of non-fused portions to which the peripheral edge of the filter are not fusion-bonded. The plurality of fused portions and the plurality of non-fused portions are arranged in an alternating manner about a lengthwise direction of the filter supporting portion.

With this configuration, protrusions used for fusion, which are to be used to fuse-bond the filter to the filter supporting portion of the case, are not required to be disposed about the entire filter supporting portion, and may instead be disposed intermittently in the lengthwise direction of the filter supporting portion. Hence, a simplified case configuration may be achieved. Additionally, fusion length may be shortened, and in this manner fusion cost may be reduced.

A fusion length corresponding to a total length of the plurality of fused portions (e.g., sum of the lengths) may be within a range from 15% to 60% of the entire length about the filter supporting portion.

With this structural configuration, the load necessary for the fused portions may be ensured and fusion cost may be reduced.

The structure including the plurality of fused portions and the plurality of non-fused portions may include at least one corner. The at least one corner has a width measured in a direction that is orthogonal to the flow direction of the fluid and that intersects with the lengthwise direction of the filter supporting portion. At least one of the plurality of fused portions may be disposed on the at least one corner.

With this configuration, the filter may be prevented from being rolled up in the proximity of the at least one corner.

### BRIEF DESCRIPTION OF THE DRAWINGS

FIG. 1 is a cross sectional view of a canister according to one embodiment;

FIG. 2 is a cross sectional view of the case body of FIG. 1 equipped with a filter;

FIG. 3 is a planar view illustrating the case body of FIG. 2 equipped with the filter;

FIG. 4 is an enlarged cross sectional view illustrating a fused portion of the case body of FIG. 1;

FIG. 5 is an enlarged cross sectional view illustrating a non-fused portion of the case body of FIG. 1;

FIG. 6 is a cross sectional view illustrating the case body of FIG. 1;

FIG. 7 is a planar view illustrating the case body of FIG. 1;

FIG. 8 is an enlarged cross sectional view illustrating a portion of the case body of FIG. 1 where a first protrusion is disposed;

FIG. 9 is an enlarged cross sectional view illustrating a portion of the case body of FIG. 1 where the first protrusion is not disposed;

FIG. 10 is a graph illustrating a relationship between a fusion length and a break strength of the filter; and

FIG. 11 is a graph illustrating a relationship between the fusion length and associated fusion cost in the case of intermittent fusion.

### DETAILED DESCRIPTION

As previously described, the long fusion length required to wholly fuse the filter to the filter supporting portion of the case in many conventional canisters is relatively complex and expensive. Accordingly, embodiments described herein are directed to canisters that offer the potential for a simplified case configuration with lower fusion costs.

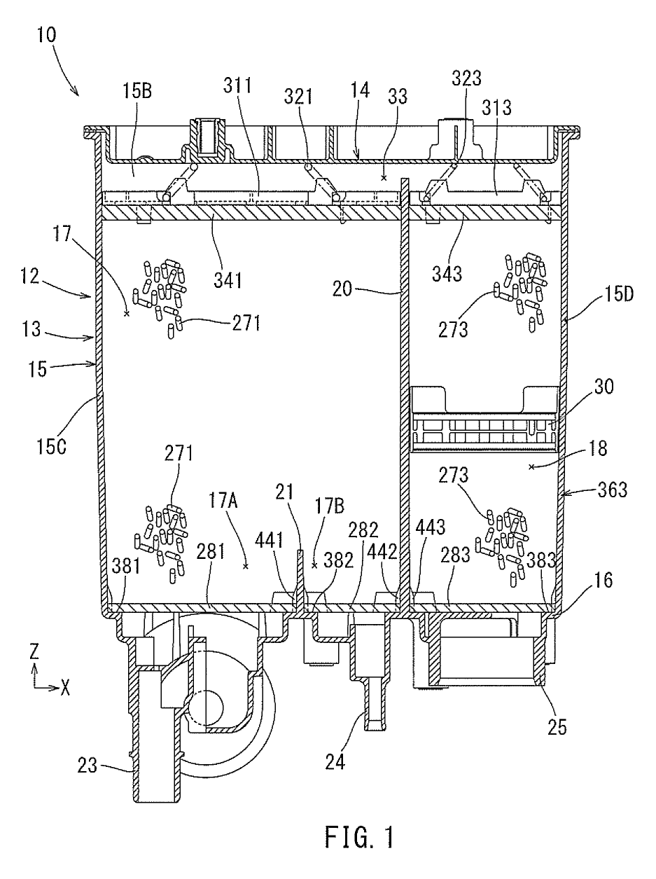

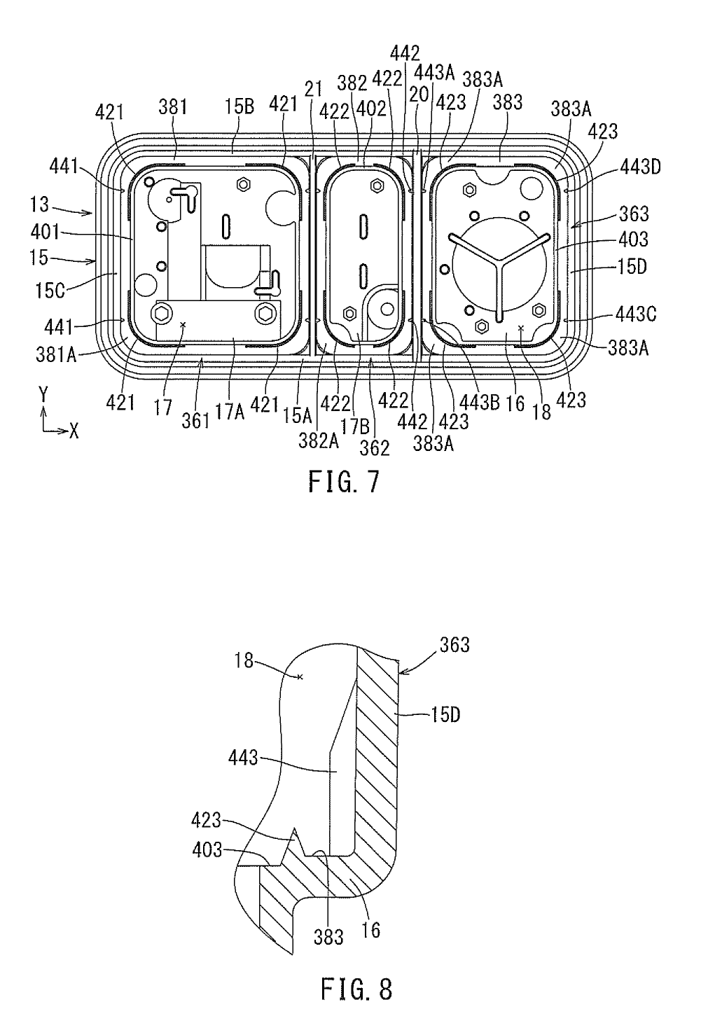

One embodiment in accordance with principles described herein will now be described with reference to the drawings. For convenience of explanation, a canister configuration will be briefly described first, followed by a description of the configuration of an attached filter. For convenience in describing relative orientations, an up-to-down direction (Z-direction) and a left-to-right direction (X-direction) are defined and used hereinafter on the basis of the orientation of the canister illustrated in FIG. 1; and a front-to-rear direction (Y-direction) is defined on the basis of the orientation of the canister illustrated in FIG. 7. These directions do not necessarily correspond to the exact respective directions of the canister when the canister is installed. That is, the canister may be installed in any orientation, and the associated directions would be relative to that orientation.

An overview of the canister structure will now be described. As illustrated in FIG. 1, the canister 10 includes a resin-molded case 12. The case 12 includes a tubular-shaped case body 13 with a closed bottom and an opening at a top; and a cover plate 14 that closes the opening at the top of the case body 13.

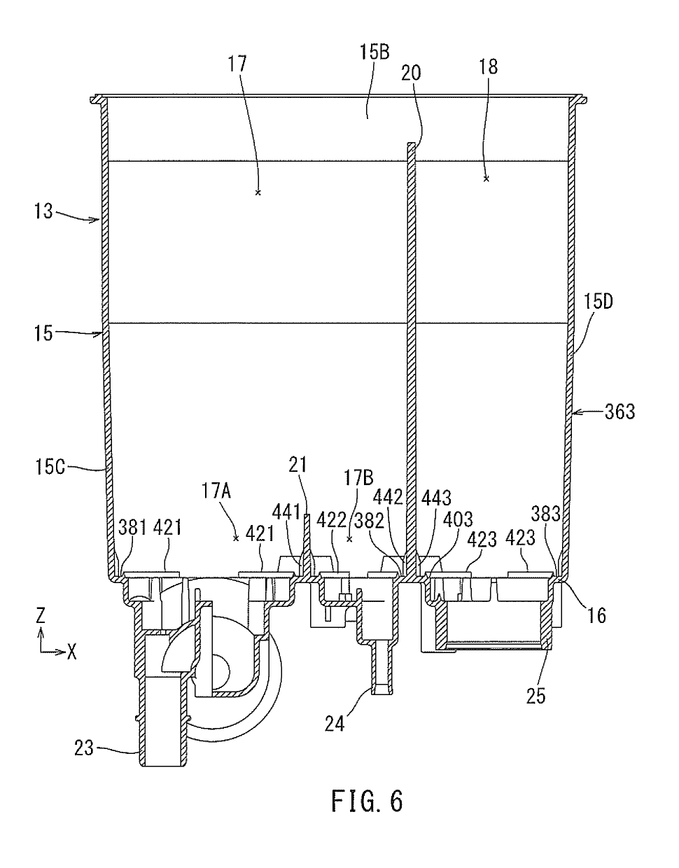

As shown in FIG. 7, the case body 13 includes a front-side wall 15A, a back-side wall 15B, a left-side wall 15C, and a right-side wall 15D, collectively forming a rectangular-tubular surrounding wall 15, and a continuously extending bottom wall 16 extending inward from the bottom edges of wall 15 (see FIG. 6). The bottom wall 16 is a wall partially covering the bottom of the case body 13. The case body 13 is, for example, made of PA66 nylon resin. It should be appreciated that in this embodiment, the surrounding wall 15 has a tubular truncated-pyramid shape that spreads moderately upward from a lower portion situated in the proximity of the bottom wall 16.

As shown in FIG. 6, a first partitioning wall 20 is formed extending upward from the upper surface of the bottom wall 16. The first partitioning wall 20 partitions an interior of the case body 13 into a first adsorption chamber 17 located at the left side and a second adsorption chamber 18 located at the right side. A second partitioning wall 21 is formed extending upward from the upper surface of the bottom wall 16 of the first adsorption chamber 17. The second partitioning wall 21 partitions the lower space of the first adsorption chamber 17 into two compartments 17A and 17B. Each compartment 17A, 17B and adsorption chamber 18 has a corresponding central axis oriented parallel to the Z-direction. Beneath the bottom wall 16 of the case body 13, a tank port 23, a purge port 24, and an atmospheric port 25, each having a cylindrical tubular-shape, are provided. These three ports are arranged from left to right, in the aforementioned described order. The tank port 23 allows the left-side compartment 17A of the first adsorption chamber 17 to communicate with the exterior of the canister 10. The purge port 24 allows the right-side compartment 17B of the first adsorption chamber 17 to communicate with the exterior of canister 10. In a similar manner, the atmospheric port 25 allows the second adsorption chamber 18 to communicate with the exterior of canister 10.

As shown in FIG. 1, the first adsorption chamber 17 and the second adsorption chamber 18 of the case body 13 are filled with adsorbent granules 271 and 273, respectively. The adsorbent granules 271 and 273 can adsorb fuel vapor generated in a fuel tank (not shown). The adsorbent granules 271 and 273 may comprise, for example, activated carbon granules. The adsorbent granules 271 and 273 may be formed of the same material and may have substantially the same average granule diameter. Filters 281, 282, and 283 in the form of gas permeable sheets are vertically interposed, respectively: between the bottom wall 16 of the case body 13 and the left-side compartment 17A of the first adsorption chamber 17; between the bottom wall 16 and the right-side compartment 17B of the first adsorption chamber 17; and between the bottom wall 16 and the second adsorption chamber 18. The filters 281, 282, and 283 may be made of the same material and may have substantially the same thickness in the Z-direction. The filters 281, 282, and 283 may be formed of the same non-woven cloth material, such as non-woven cloth containing a fiber blend containing polyester fibers and rayon fibers.

A gas-permeable buffer plate 30 is horizontally positioned inside the second adsorption chamber 18 in a vertically-movable manner, and serves to vertically partition the adsorbent granules 273, which are filled throughout the adsorption chamber 18, into upper and lower portions. Also, the gas-permeable push plates 311 and 313 are each horizontally arranged to cover a corresponding opening at the top of the one of the both adsorption chambers 17 and 18, respectively, in a vertically movable manner. A spring 321 comprising a coil spring is vertically interposed between the push plate 311 and the cover plate 14 (above the push plate 311 and below the cover plate 14), thereby biasing the push plate 311 downward in an elastic manner. Similarly, a spring 323 comprising a coil spring is vertically interposed between the push plate 313 and the cover plate 14 (above the push plate and below the cover plate), thereby biasing the push plate 313 downward in an elastic manner. Adsorption chambers 17 and 18 communicate with each other through a vertical gap between the cover plate 14 and the first partitioning wall 20 (above said first partitioning wall 20 and below the cover plate 14). With this structural configuration, an inverted U-shaped fluid channel 33 is formed within the case 12. A fluid (e.g., gas containing fuel vapor) flows through the fluid channel 33. In other words, within both adsorption chambers 17 and 18, the fluid flows in the up-to-down direction (the Z-direction). The fluid channel 33 is a channel allowing the tank port 23 and the purge port 24 at the bottom of the first adsorption chamber 17 to communicate with the atmospheric port 25 at the bottom of the second adsorption chamber 18 in an indirect manner. Additionally, filters 341 and 343 in the form of gas permeable sheets are disposed on either side of the first partitioning wall 20: vertically between the push plate 311 in the first adsorption chamber 17 and the adsorbent granules 271 (below the push plate 311 and above the adsorbent granules 271); and vertically between the push plate 313 in the second adsorption chamber 18 and the adsorbent granules 273 (below the push plate 313 and above the adsorbent granules 273), respectively. The filters 341 and 343 may be formed of urethane foam or the like.

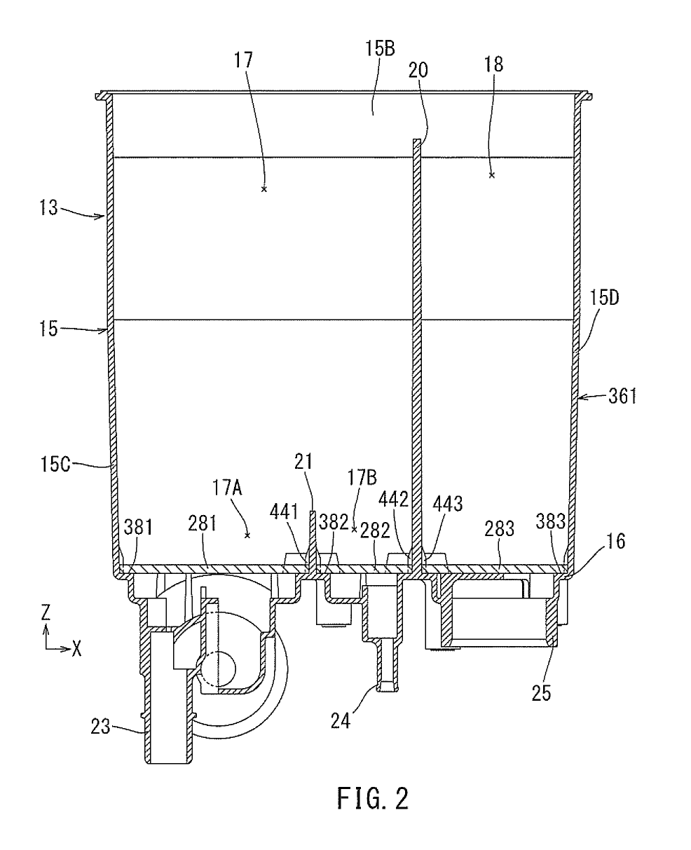

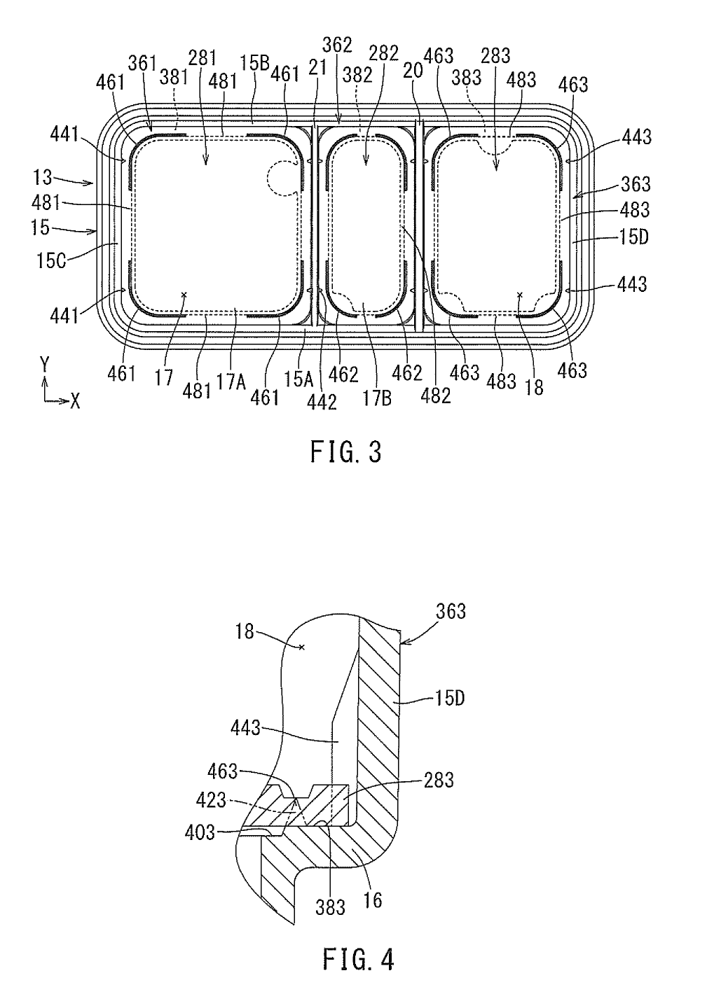

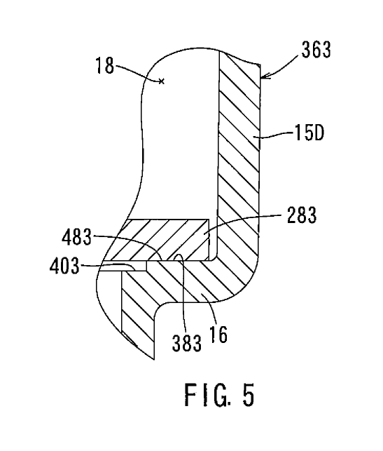

Filters 281, 282, and 283 will now be described. As shown in FIGS. 2 and 3, within the case body 13, filters 281 and 282 within compartments 17A and 17B, respectively, of the first adsorption chamber 17, as well as filter 283 within the second adsorption chamber 18, are each attached in substantially the same manner. Accordingly, the structural configuration and installation procedures will be described with respect to the filter 283 within the second adsorption chamber 18 as well as relevant members and/or components, with the understanding that the filters 281 and 282 within the compartments 17A and 17B, respectively, are configured and installed in a similar manner. It is notable that members or components that are installed in the compartments 17A and 17B of the first adsorption chamber 17 and the second adsorption chamber 18, respectively, and that have substantially the same function have the same numeral at the hundreds place and the tens place in three-figure numerals, and are distinguished by a different numeral (i.e., 1, 2, and 3) at the ones place. When it is unnecessary to distinguish, the numerals located at ones place are omitted and the numerals given for the common members or components become two-digits.

As shown in FIG. 7, a surrounding wall 363 of the second adsorption chamber 18 forms a rectangular-tubular shape bounded by the front-side wall 15A, the back-side wall 15B, the right-side wall 15D, and the first partitioning wall 20 of the case body 13. A surrounding wall 361 of the left-side compartment 17A similarly forms a rectangular-tubular shape bounded by the front-side wall 15A, the back-side wall 15B, the left-side wall 15C, and the second partitioning wall 21 of the case body 13. In a similar manner, a surrounding wall 362 of the right-side compartment 17B forms a rectangular-tubular shape bounded by the front-side wall 15A, the back-side wall 15B, the first partitioning wall 20, and the second partitioning wall 21 of the case body 13.

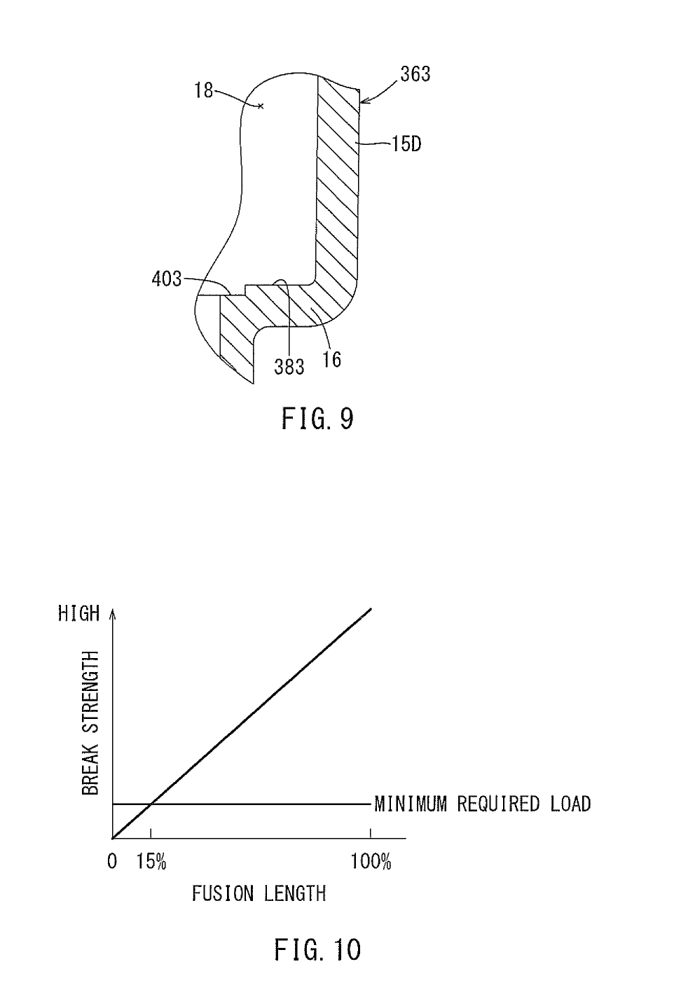

The bottom wall 16 includes a filter supporting portion 383 that is situated inside the second adsorption chamber 18 and is formed by a part of the upper surface of the bottom wall 16, in particular, a radially outer peripheral portion of the upper surface of the bottom wall 16. The filter supporting portion 383 forms a planar surface extending in an X-Y plane, which is a plane orthogonal to the up-to-down vertical direction (the Z-direction). The bottom wall 16 also includes a stepped face 403 situated radially inward of the filter supporting portion 383. The stepped face 403 and the filter supporting portion 383 collectively form a stepped structure with several steps in the vertical direction. The stepped face 403 is orthogonal to the Z-direction (that is the stepped face 403 extends within the X-Y plane) and has a planar face in an X-Y plane situated radially inward of, and at a lower level than, the filter supporting portion 383 (FIGS. 8 and 9).

As illustrated in FIG. 7, the filter supporting portion 383 has a substantially rectangular structure. More specifically, the filter supporting portion 383 has a rectangular shape with four rounded corners. Thus, the filter supporting portion 383 has four corner portions 383A, each having a rounded structure. Each of the corner portions 383A extends within the X-Y plane generally along the lengthwise direction of the filter supporting portion 383. On each corner portion 383A, a first protrusion 423, which is a protrusion in the upwards Z-direction, is formed for fusion-bonding. Each protrusion 423 extends along the filter supporting portion 383 in the lengthwise direction of the filter supporting portion 383, and has an arc-length of approximately a quarter of a circle (FIGS. 6 and 8). The filter 283 is bonded to the first protrusions 423 by fusion. As mentioned, the protrusions 423 each include a substantial arc structure curved along the inner peripheral edge of the corresponding corner portion 383A. As illustrated in FIG. 8, each first protrusion 423 has a triangular cross-section protruding upward from the filter supporting portion 383.

As illustrated in FIG. 7, no first protrusion 423 is disposed between any two first protrusions 423 adjacent to each other in both the X and Y directions along the filter supporting portion 383.

It is preferable that a total length of the first protrusions 423 (e.g., sum of the lengths of all the first protrusions 423) is set within a range from 15% to 60% of the entire length of the filter supporting portion 383. This means that it is preferable that the ratio of a total length of the first protrusions 423 (e.g., sum of the lengths of all the first protrusions 423) to the total length of the filter supporting portion 383 is set within a range from 15% to 60%.

Within the second adsorption chamber 18, a lower end portion of each of left and right inner faces of the surrounding wall 36 includes a pair of second protrusions 443 in the radially inward direction (FIGS. 6 and 8). As shown in FIG. 7, there are four such second protrusions 443, on opposing left and right sides, distinguished by numerals 443A to 443D. When described in general, the second protrusions are just referred to as the second protrusions 443. The second protrusions 443A and 443B are arranged on the left X side in the front-to-rear direction (the Y-direction), and constitute a first pair of second protrusions 443. Similarly, the second protrusions 443C and 443D are arranged in the front-to-rear direction (the Y-direction) on the right X side, and constitute a second pair of protrusions 443 further along the X axis than the first pair. The first pair and the second pair are arranged symmetrically in the left-to-right direction (the X-direction) about the Y directional axis extending through the radial center of the second adsorption chamber 18 in the front-to-rear direction. Structurally, at the lower portion of the inner face of the surrounding wall 36, the second protrusions 443 are in the form of ribs extending radially inward of the wall along the up-to-down direction (the Z-direction). The second protrusions 443 are formed such that the outer radial peripheral edge of the filter 283 makes contact with the second protrusions 443 in an elastic manner. The second protrusions 443 are arranged at a radially outer position as compared to the first protrusions 423.

As illustrated in FIG. 3, within the confines of surrounding wall 363 of the second adsorption chamber 18, the filter 283 is capable of fitting horizontally in the X-Y plane with no substantial gaps between the filter supporting portion 383 and the filter 283 in the X, Y, or Z directions (FIG. 2). Further, a portion of the outer radial peripheral edge of the filter 283 is capable of elastically contacting each second protrusion 443 (FIG. 4).

Next, the installation of the filter 283 in the case body 13 will be described. The filter 283 is fitted within the second adsorption chamber 18 horizontally in the X-Y plane, with no substantial gap in the X, Y, or Z directions between the filter supporting portion 383 and the filter 283. That is, the filter 283 is installed in the second adsorption chamber 18 so as to be orthogonal to the flow direction of the fluid. If the installation process is performed by an automated assembly line, the filter 283 is moved vertically downward from above the second adsorption chamber 18 while maintaining a horizontal orientation in the X-Y plane, and while being sucked to an suction disc of a suction device (not shown) utilizing a negative pressure; and is thereby set on the filter supporting portion 383, which is on the bottom wall 16 and includes the first protrusions 423. At this time, portions of the outer radial peripheral edge of the filter 283 elastically contact the second protrusions 443 by utilizing the elasticity of the filter 283. By this contact, the filter 283 is temporarily fixed to the case body 13. Negative pressure applied to the filter 283 by the suction device is then released and the suction disc is discharged out of the second adsorption chamber 18.

Subsequently, ultrasonic vibration is applied to a welding horn of an ultrasonic welding device (not shown) while the welding horn is pressed against a portion of the filter 283. By using the welding horn in this manner, the first protrusions 423 and the outer radial arc portions of the filter 283, each oppositely facing the corresponding first protrusion 423, are melted and bonded (i.e., fusion-bonded) to each other. It is notable that each protrusion 423 is fusion-bonded with the filter 283 via at least a portion of the protrusion 423 including the vertex of the triangular cross-section thereof. Portions of the filter supporting portion 383 to which portions of filter 283 are respectively fusion-bonded will be hereinafter referred to as fused portions 463 (see FIG. 3). FIG. 4 illustrates one of the fused portions 463.

The welding horn is allowed to transmit vibrations to the first protrusions 423 and is not allowed to transmit vibrations to portions of the filter supporting portion 383 with no first protrusion 423. Thus, each of the portions of filter 283, which face the corresponding portion of the filter supporting portion 383 with no first protrusion 423, is laid over the corresponding portion of the filter supporting portion 383 and is not fused to be bonded to said portion. Each of the portions of the filter supporting portion 383 to which a portion of the filter 283 is not fusion-bonded is referred to as a non-fused portion 483 (FIG. 3).

The filter supporting portion 383 includes four fused portions 463 and four non-fused portions 483 disposed in an alternating manner along the lengthwise direction of the filter supporting portion 383 (FIG. 3). The total length of the fused portions 463 (e.g., sum of the lengths of all the fused portions 463) may be 15% to 60% of the entire length of the filter supporting portion 383. Additionally, each of the fused portions 463 may have the same length measured in the lengthwise direction of the filter supporting portion 383, and the fused portions 463 may be arranged in a point symmetrical manner and/or a line symmetrical manner. The structure including the fused portions 463 and the non-fused portions 483 includes four rounded corners. The corners each have a width measured in an X-Y plane (e.g., a plane oriented perpendicular to the Z-direction) generally perpendicular to the central axis of the second adsorption chamber 18 and that intersects with the lengthwise direction of the filter supporting portion 383. In other words, a width of each corner is measured orthogonal to the flow direction of the fluid within the second adsorption chamber 18 and intersects with the lengthwise direction of the filter supporting portion 383. The fused portions 463 are disposed on the four corners.

After application of ultrasonic vibration is stopped, the welding horn is discharged out of the second adsorption chamber 18. Filters 281 and 282 are attached to the compartments 17A and 17B, respectively, of the first adsorption chamber 17 (FIGS. 2 and 3) in a similar manner to the filter 283 as described above.

In this manner, the filters 281, 282, and 283 are attached to the case body 13. After these filters are attached, the respective adsorption chambers 17 and 18 of the case body 13 are filled with the adsorbent granules 271 and 273. Subsequently, the buffer plate 30, the push plates 311 and 313, springs 321 and 323, and filters 341 and 343, etc. are attached to the canister, followed by closing the opening at the top of the case body 13 with the cover plate 14. The canister 10 is thus finished (see FIG. 1).

According to the above-described canister 10, after the fusing process takes place, the filter supporting portion 38 of the case 12 includes the fused portions 46, to which portions of the filter 28 are fusion-bonded, and the non-fused portions 48 to which the peripheral edge of the filter are not fusion-bonded, where fusion-bonded and non-fused portions of the filter 28 are placed in an alternating manner about the filter supporting portion 38 in the lengthwise direction of the filter supporting portion 38. Accordingly, the first protrusions 42 for fusing portions of the filter 28 on the filter supporting portion 38 are not required to be formed about the entire filter supporting portion 38, and may instead be formed intermittently in the lengthwise direction of the filter supporting portion 38, thereby simplifying the configuration of the case 12. Further, in this manner, the fusion length can be shortened and fusion cost can be reduced, wherein said design is applied to compartments 17A and 17B of the first adsorption chamber, as well as the second adsorption chamber 18.

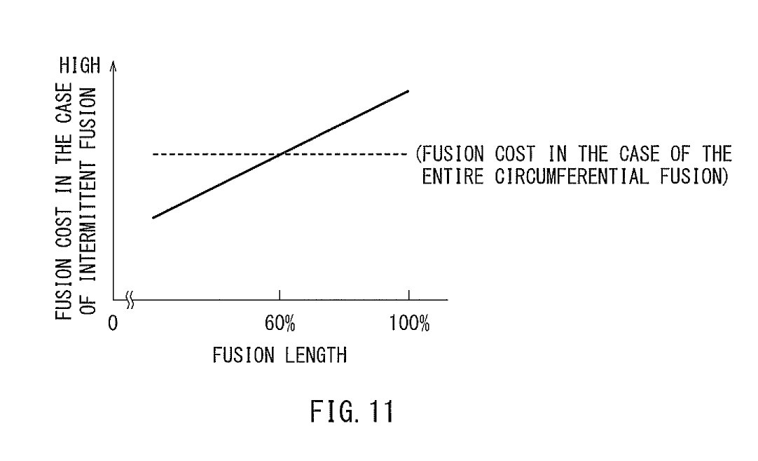

FIG. 10 is a graph illustrating the relationship between the fusion length and break strength for each of the compartments 17A and 17B of the first adsorption chamber 17, as well as the second adsorption chamber 18. FIG. 10 indicates that it is generally preferable that the total length of each of the fused portions 46 is set to be greater than 15% of the entire length of the filter supporting portions 38. Such a setting as per FIG. 10 can achieve a minimum break strength necessary to keep the filters 28 held onto the case 12 and satisfying the requisite fusion strength needed for fusion between the filter 28 and the case 12. FIG. 11 also shows a graph, which illustrates the relationship between the fusion length when intermittent fusion is performed and fusion cost for each of the compartments 17A and 17B of the first adsorption chamber 17 and the second adsorption chamber 18. The example shown in FIG. 11 indicates that it is preferable that the total length of the fused portion 46 (e.g., sum of the lengths of all the fused portions 46) is set to be less than 60% of the entire length of each filter supporting portions 38. Such a setting can reduce the cost required to fuse the filter 28 to the case 12 as compared to the cost required for fusing the entire length (see the broken line in FIG. 11). Accordingly, setting the total length of the fused portions 46 within a range from 15% to 60% of the entire length may allow for reducing fusion cost while ensuring the load necessary for the fused portions 46.

Further the structure including the fused portions 46 and non-fused portions 48 within each of the compartments 17A and 17B of the first adsorption chamber 17, as well as the second adsorption chamber 18, includes the four corners that each have a width measured in an X-Y plane (e.g., a plane oriented perpendicular to the Z-direction) generally perpendicular to the central axis of the corresponding compartment 17A, 17B or adsorption chamber 18 and that intersects with the lengthwise direction of the filter supporting portions 38. In other words, a width of each corner is measured perpendicular to the lengthwise direction of the filter supporting portion 38. The fused portions 46 are disposed on the four corners of each of the filter supporting portions 38. With this configuration, corner portions of the filter 28 may be prevented from being rolled up at the four protruding portions.

The present disclosure is not intended to be limited to the above-described embodiment and the above embodiment may be modified in various ways. For example, a structure including a plurality of fused portions 46 and non-fused portions 48 is not limited to a rectangular structure and may be another polygonal structure such as a triangular or hexagonal structure. In this context, the term “polygonal structure” includes a structure that is obtained by rounding corners of a polygonal structure. Additionally, a structure may be a sector-shaped structure or a structure having at least one corner having a width measured in an X-Y plane (e.g., a plane oriented perpendicular to the Z-direction) and that intersects with the lengthwise direction of the structure. In case of a structure having at least one corner, it is only necessary that the fused portion(s) 46 is disposed on the at least one corner. A structure including a plurality of fused portions 46 and non-fused portions 48 may have a circular, semi-circular, or elliptic shape. Several pairs of the fused portions 46 each may be disposed in an alternating manner with a tiny gap therebetween to extend along the structure. The various examples described above in detail with reference to the attached drawings are intended to be representative and thus not limiting. The detailed description is intended to teach a person of skill in the art to make, use and/or practice various aspects of the present teachings and thus is not intended to limit the scope of the invention. Furthermore, each of the additional features and teachings disclosed above may be applied and/or used separately or with other features and teachings to provide improved canisters, and/or methods of making and using the same. Moreover, the various combinations of features and steps disclosed in the above detailed description may not be necessary to practice the invention in the broadest sense, and are instead taught to describe representative examples of the invention. Further, various features of the above-described representative examples, as well as the various independent and dependent claims below, may be combined in ways that are not specifically and explicitly enumerated in order to provide additional useful embodiments of the present teachings. All features disclosed in the description and/or the claims are intended to be disclosed as informational, instructive and/or representative and may thus be construed separately and independently from each other. In addition, all value ranges and/or indications of groups of entities are also intended to include possible intermediate values and/or intermediate entities for the purpose of original written disclosure, as well as for the purpose of restricting the claimed subject matter.

What is claimed is:

1. A canister comprising:
a case having a fluid channel therein;
an adsorption chamber disposed in the fluid channel and containing an adsorbent; and
a filter disposed within the adsorption chamber and extending across an end portion of the adsorption chamber in a direction orthogonal to a flow direction of a fluid, wherein:
the case includes a filter supporting portion facing an outer peripheral edge of the filter;
the filter supporting portion includes a plurality of fused portions to which the outer peripheral edge of the filter is fusion-bonded and a plurality of non-fused portions to which the outer peripheral edge of the filter is not fusion-bonded; and
the plurality of fused portions and the plurality of non-fused portions are arranged in an alternating manner in a lengthwise direction of the filter supporting portion about the filter supporting portion.

2. The canister of claim 1, wherein a total length of the plurality of fused portions is within a range from 15% to 60% of a length of the filter supporting portion, wherein the length of each fused portion and the length of the filter supporting portion are measured in the lengthwise direction of the filter supporting portion.

3. The canister of claim 1, wherein:
the structure including the plurality of fused portions and the plurality of non-fused portions includes at least one corner having a width measured in a direction that is orthogonal to the flow direction of the fluid and that intersects with the lengthwise direction of the filter supporting portion; and
at least one of the plurality of fused portions is disposed on the at least one corner.

4. The canister of claim 3, wherein:
the structure includes a plurality of corners and a plurality of substantially straight portions connecting the plurality of corners;
each of the plurality of corners has an arc-shaped curved portion, and
each of the plurality of non-fused portions is disposed on one of the plurality of substantially straight portions.

5. The canister of claim 1, wherein:
the structure includes four fused portions and four non-fused portions;
the structure includes four corners each having a width measured in a direction orthogonal to the flow direction of the fluid and that intersects with the lengthwise direction of the filter supporting portion; and
each of the four fused portions is disposed on one of the four corners.

6. The canister of claim 1, wherein the canister comprises a plurality of adsorption chambers, wherein each adsorption chamber includes a port on one end face configured to allow a corresponding adsorption chamber to communicate with the exterior of the canister.

7. The canister of claim 1, the plurality of fused portions are arranged in a point symmetrical manner.

8. The canister of claim 1, the plurality of fused portions are arranged in a line symmetrical manner.

9. The canister of claim 1, wherein each of the plurality of fused portions has the same length measured in the lengthwise direction of the filter supporting portion.

10. The canister of claim 1, wherein each of the plurality of fused portions is arranged on a protrusion and each of the plurality of non-fused portions is arranged on a flat surface.

11. The canister of claim 10, wherein each protrusion with one of the plurality of fused portions thereon has a triangular cross-section.

12. The canister of claim 10, wherein the protrusion forms an upward protruding triangular cross-section in a vertical plane perpendicular to the filter.

13. The canister of claim 12, wherein the upward protruding triangular cross-section of the protrusion does not extend upward through the filter.

14. A canister comprising:
a case having a fluid channel therein;
an adsorption chamber disposed in the fluid channel and containing an adsorbent; and
a filter disposed within the adsorption chamber and extending across an end portion of the adsorption chamber in a direction orthogonal to a flow direction of a fluid, wherein:
the case includes a filter supporting portion facing an outer peripheral edge of the filter;
the filter supporting portion includes a plurality of fused portions to which the outer peripheral edge of the filter is fusion-bonded and a plurality of non-fused portions to which the outer peripheral edge of the filter is not fusion-bonded; and
a total length of the plurality of fused portions is within a range from 15% to 60% of a length of the filter supporting portion, wherein the length of each fused portion and the length of the filter supporting portion are measured in the lengthwise direction of the filter supporting portion.

15. A canister comprising:
a case having a fluid channel therein;
a plurality of adsorption chambers, where each adsorption chamber defines a part of the fluid channel, and wherein each adsorption chamber contains an adsorbent; and
a horizontally oriented filter disposed in a bottom end portion of each adsorption chamber, wherein each filter extends across the bottom end portion of the corresponding adsorption chamber in a direction orthogonal to a flow direction of a fluid, wherein:
each adsorption chamber includes a filter supporting portion in the same general shape as the filter, the filter supporting portion facing an outer peripheral edge of the filter;
the filter supporting portion of each adsorption chamber includes a plurality of fused portions to which the outer peripheral edge of a corresponding filter is fusion-bonded to include an arc shape in a horizontal plane, and a plurality of non-fused portions to which the outer peripheral edge of the corresponding filter is not fusion-bonded; and
a total length of the plurality of fused portions of each filter supporting portion is within a range from 15% to 60% of a length of the filter supporting portion, wherein the length of each fused portion and the length of the filter supporting portion are measured in the lengthwise direction of the filter supporting portion.

16. The canister of claim 15, wherein:
the flow direction of the fluid in each part of the fluid channel defined by a corresponding one of the plurality of adsorption chambers is a vertical direction;
each adsorption chamber is filled with an adsorbent positioned vertically above the filter.

17. The canister of claim 16, wherein:
the canister includes a first adsorption chamber, a second adsorption chamber, and a third adsorption chamber;
the first adsorption chamber, the second adsorption chamber, and the third adsorption chamber define a first part, a second part, and a third part, respectively, of the fluid channel;
the first, second, and third chambers are arranged such that the second chamber is positioned between the first chamber and the third chamber; and
the first and second adsorption chamber are in direct fluid communication with each other, whereas the first and second adsorption chambers are in indirect communication with the third adsorption chamber via an inverted U-shaped fluid channel disposed above the first part, the second part, and the third part of the fluid channel.

18. The canister of claim 17, wherein each adsorption chamber has a central axis and an inner surface, wherein a distance measured about the inner surface of each adsorption chamber in a plane oriented perpendicular to the central axis of the corresponding adsorption chamber is different.

19. The canister of claim 18, wherein each adsorption chamber has a different shape.
